(19) United States
(12) Patent Application Publication
(10) Pub. No.: US 2026/0367933 A1
(43) Pub. Date: Nov. 19, 2026

(54) SYSTEM AND METHOD FOR INTEGRATING AI AGENTS WITH HOST-APPLICATION-SPECIFIC ADD-INS

(71) Applicant: Microsoft Technology Licensing, LLC, Redmond, WA (US)

(72) Inventors: Matthew Steven GEIMER, Lynnwood, WA (US); Bryan Joseph REICH, Snoqualmie, WA (US); Zhaonan LIU, Seattle, WA (US); Ming Fung Philip TAI, Bellevue, WA (US); Ivan SLASTENIN, Belgrade (RS); Deepesh SATIJA, Dwarka (IN); Akash Kumar GOEL, Greater Noida West (IN); Amandeep Amandeep, Sirsa (IN); Jaspreet SINGH, Yamunanagar (IN); Jose Julian ARGIL TORRES, Sammamish, WA (US); Joshua Alan LEDGARD, Seattle, WA (US)

(73) Assignee: Microsoft Technology Licensing, LLC, Redmond, WA (US)

(21) Appl. No.: 19/210,315

(22) Filed: May 16, 2025

(51) Int. Cl. G06F 9/445; G06F 16/958; G06F 21/62; G06Q 10/0631

(52) U.S. Cl. CPC G06F 9/44526; G06F 16/958; G06F 21/629; G06Q 10/06316

(57) ABSTRACT

A data processing system implements receiving a user query via an AI agent within a UI of a host application on a client device; prompting a GenAI model to determine, based on the user query and unified manifest information, a plan of executing action(s) upon a host-specific digital content item in the host application by corresponding add-in(s), the unified manifest information containing action definitions each mapped to a pair of a declarative agent of the AI agent and an add-in associated with the host application; requesting the add-in(s) by the host application via an API to perform the action(s) and generate output(s) according to the plan, the API being used in building the add-in(s); receiving, at the host application from the add-in(s), the output(s) as a response to the user query; and updating the host-specific digital content item in the host application based on the response on the UI.

### BACKGROUND

Expanding AI-powered assistant capabilities has become increasingly popular due to the growing demand for smarter, more intuitive digital experiences that boost productivity, streamline workflows, and personalize user interactions. For example, Microsoft Declarative Agents® (DA) can access Microsoft 365 data, integrate with external systems, and respond to natural language inputs by invoking actions or retrieving knowledge, without requiring custom prompt engineering or manual logic. However, the existing DAs enable a small set of scenarios including grounding via graph connectors, web search, and application programming interface (API) plugins to call external representational state transfer (REST) services, thereby providing simple insertion to and selection from productivity software applications such as the Office® canvas. These scenarios provide chatbots and some simple integration capabilities but lack the access to thousands of productivity software add-ins and their rich capabilities. Thus, there is a need for improved systems and methods that provide full access to thousands of productivity software add-ins and their rich capabilities via an AI conversational interface.

### SUMMARY

An example data processing system according to the disclosure includes a processor and a machine-readable medium storing executable instructions. The instructions when executed cause the processor alone or in combination with other processors to perform operations including receiving a user query via an artificial intelligence (AI) agent within a user interface of a host application on a client device, wherein the user query involves a host-specific digital content item in the host application; prompting a generative AI model to determine, based on the user query and unified manifest information, a plan of executing one or more actions upon the host-specific digital content item by one or more corresponding add-ins associated with the host application, wherein the unified manifest information contains action definitions each of which is mapped to a pair of a declarative agent of the AI agent and an add-in associated with the host application, and mapping information from a user intent to one or more actions; requesting the one or more corresponding add-ins by the host application via an application programming interface (API) to perform the one or more actions and generate one or more outputs according to the plan, the API being used in building the one or more corresponding add-ins; receiving, at the host application via the API from the one or more corresponding add-ins, the one or more outputs as a response to the user query; and updating the host-specific digital content item in the host application based on the response on the user interface of the client device.

An example method implemented in a data processing system includes receiving a user query via an artificial intelligence (AI) agent within a user interface of a host application on a client device, wherein the user query involves a host-specific digital content item in the host application; prompting a generative AI model to determine, based on the user query and unified manifest information, a plan of executing one or more actions upon the host-specific digital content item by one or more corresponding add-ins associated with the host application, wherein the unified manifest information contains action definitions each of which is mapped to a pair of a declarative agent of the AI agent and an add-in associated with the host application, and mapping information from a user intent to one or more actions; requesting the one or more corresponding add-ins by the host application via an application programming interface (API) to perform the one or more actions and generate one or more outputs according to the plan, the API being used in building the one or more corresponding add-ins; receiving, at the host application via the API from the one or more corresponding add-ins, the one or more outputs as a response to the user query; and updating the host-specific digital content item in the host application based on the response on the user interface of the client device.

An example non-transitory computer readable medium according to the disclosure on which are stored instructions that, when executed, cause a programmable device to perform functions of receiving a user query via an artificial intelligence (AI) agent within a user interface of a host application on a client device, wherein the user query involves a host-specific digital content item in the host application; prompting a generative AI model to determine, based on the user query and unified manifest information, a plan of executing one or more actions upon the host-specific digital content item by one or more corresponding add-ins associated with the host application, wherein the unified manifest information contains action definitions each of which is mapped to a pair of a declarative agent of the AI agent and an add-in associated with the host application, and mapping information from a user intent to one or more actions; requesting the one or more corresponding add-ins by the host application via an application programming interface (API) to perform the one or more actions and generate one or more outputs according to the plan, the API being used in building the one or more corresponding add-ins; receiving, at the host application via the API from the one or more corresponding add-ins, the one or more outputs as a response to the user query; and updating the host-specific digital content item in the host application based on the response on the user interface of the client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for integrating AI agents with host-application-specific add-ins are implemented.

FIG. 2A is a high-level flow diagram for integrating an AI agent with host-application-specific add-ins from the perspective of the AI agent of the system of FIG. 1.

FIGS. 2B-2C is an API call flow diagram for integrating the AI agent with the host-application-specific add-ins of the system of FIG. 1.

FIG. 2D is a sequence diagram of applying the API call flow depicted in FIGS. 2B-2C to a different scenario.

FIGS. 3A-3D are example user interfaces of the system for integrating an AI agent with host-application-specific add-ins that implement the techniques described herein.

FIG. 4 is a flow chart of an example process for providing the email system integrating AI agents with host-application-specific add-ins according to the techniques disclosed herein.

FIG. 5 is a block diagram showing an example software architecture, various portions of which may be used in conjunction with various hardware architectures herein described, which may implement any of the described features.

FIG. 6 is a block diagram showing components of an example machine configured to read instructions from a machine-readable medium and perform any of the features described herein.

### DETAILED DESCRIPTION

Deep integrations have been built by third parties in office productivity software products (such as Microsoft Office® applications, Google Workspace® applications, and the like) as add-ins. Popular third-party productivity software add-ins enhance the functionalities of these productivity software products by integrating external tools and services. These add-ins utilize host-specific APIs to manipulate a document canvas and use host-specific features in these office productivity software products. For example, Grammarly® for Word® and Outlook® helps users improve writing with grammar and style suggestions, while DocuSign® allows for seamless electronic signatures directly within Office® apps. Project management tools like Trello® and Smartsheet® integrate with Outlook® and Excel®, helping users manage tasks and collaborate more efficiently. Additionally, Mendeley® add-in helps academic users insert citations and create bibliographies in Word®, and Icertis add-in enables single-clause replacement inline in Word® from an AI agent, and provides formatting/markup of pertinent sections related to a user's request based on the entire document context. Templafy® add-in enables users to utilize standard company assets insertion in Word® and PowerPoint®, and to create new documents and presentations from templates that are customizable via a wizard-type experience. These add-ins provide a variety of productivity boosts, making productivity software applications more versatile and connected with other platforms, but may not be installed or available for general access. The issue is that when a generative AI is incorporated into a host application of an add-in, the generative AI model does not readily access the everchanging/proprietary add-ins, and would need to be trained and implemented.

As mentioned, the existing DAs extends AI capabilities by enabling API plugins to call REST services. For example, in Microsoft Copilot®, REST API plugins are stored as part of a ZIP file containing OpenAPI specification, an API plugin manifest, and an app manifest, which are then uploaded and managed through a low-code platform for creating and deploying AI-powered chatbots and agents (e.g., Copilot Studio®). API plugins enable DAs in Copilot® to interact with REST APIs that have an OpenAPI description. Users can ask a DA to query a REST API for information, and to create, update, and delete data and objects. The REST services allow generative AI models and applications to interact over the internet using API plugins with standard HTTP verbs (e.g., get, post, put, delete, and the like) as description sent to callable endpoints. Anything the REST API can do is accessible via natural language prompts. For example, an AI-powered image recognition REST API can accept an image file via a POST request and respond with labels identifying objects in the image. Although these services enable external systems to send data to generative AI models, such as text, images, or sensor data, and receive results like predictions, classifications, or insights in return, these HTTP verbs limit the capabilities of the REST plugins.

The existing DA API plugins simply do not support full access to thousands of productivity software applications add-ins and their rich capabilities, such as canvas manipulation and data selection capabilities, and more. Due to the ongoing expansion of the productivity software suite add-in ecosystem, it has become increasingly desirable to enable AI agent active in a host application to interact with add-in functionalities via an AI conversational interface that users crave beyond a limited set of features of the existing DA API plugins systems, thereby integrating rich add-ins capabilities with AI capabilities via host applications without needing to run or manage the AI models locally.

To address the above-discussed technical problems, the AI agent and add-in integration approach links together an AI agent (via an API plugin) and host-specific add-ins (such as via JavaScript capabilities, e.g., office.js), thereby filling the gap between the AI agent and the host-specific add-ins. In other words, the AI agent and add-in integration approach combines the AI agent and add-in workflows to enable the AI agent to utilize the existing add-in ecosystem and the respective API space, by passing a small amount of information between these two separate execution systems. This AI agent and add-in integration approach uses an AI agent API and JavaScript capabilities of add-ins to connect a generative AI model via the host application to specialized capabilities of the add-ins, thereby providing a specialized DA without new training or creating a new generative AI model.

Although various embodiments are described with respect to JavaScript, it is contemplated that the AI agent and add-in integration approach described herein may be written in other software languages such as Python, Java, PHP, and other languages, depending on the add-in type and the target platform. For example, TypeScript, a typed superset of JavaScript, is also commonly used for Office Web Add-ins to provide better tooling and maintainability.

In particular, the AI agent and add-in integration approach introduces a new plugin capability of scopes in a DA manifest, thereby supporting calling a plugin capability via a host application which in turn calls action(s)/function(s) in an add-in corresponding to a user query. The “scopes” define the specific permissions or access levels the plugin is requesting, such as reading user data, writing content, or accessing external APIs, thereby ensuring that the plugin only performs actions explicitly granted by the user or host application. In another implementation, “allowed_hosts” specifies the domains or IP addresses the plugin is permitted to interact with, effectively creating a security boundary by restricting network communication to trusted endpoints. The same specification format of the DA manifest is applied to plugin manifests and add-in manifests. These manifests contain action/function definitions in both the DA and add-in json files with a 1:1 mapping.

The AI agent and add-in integration approach calls via a JavaScript-based API (e.g., Office.js API) an add-in with action(s)/function(s) determined from the DA/add-in manifest mapped to the user query/intent, to pass control from the AI agent to the add-in to handle the action(s)/function(s), and callback from the add-in to complete the action(s)/function(s) execution. A user interface is enabled within the host application for users to interact with the AI agent to complete the action(s)/function(s) within the add-in without an actual agent trained for that add-in.

In one implementation, the host application and the add-in are web-based, and the add-in extends and customizes the host application through its capabilities. Since the add-in is tightly integrated with the host application, and runs within the context of the host application, the AI agent can interact seamlessly with the add-in within the host application, thereby manipulating host-specific documents/objects using the add-in capabilities. This allows the AI agent to call the add-in and to interact with a digital content item in the host application (e.g., a document, spreadsheet, or presentation) and/or host-specific objects directly within the host application. For example, in response to a user query via the AI agent within a spreadsheet application to check whether a potential purchase will exceed the budget, the AI agent maps the user query to a spreadsheet add-in for budgeting, calls the spreadsheet add-in via the spreadsheet application to fetch budget data, calculates an answer to the query for the user, and then presents the answer to the user via an AI chat.

The technical benefit of the AI agent and add-in integration approach provided herein are to enable AI agents to utilize the existing host-specific add-in solutions and their rich capabilities, thereby creating more powerful capabilities of both the add-ins and the AI agents.

Another technical benefit of the AI agent and add-in integration approach is to utilize existing investments in host-specific add-ins to empower AI agents without requiring large investments in the AI agent ecosystem. In particular, the approach integrates existing host-specific add-ins into the existing AI agent ecosystem in a host application through a bridge, instead of building AI directly into the host-specific add-ins, or waiting for support to be built in the AI Agent ecosystem for APIs to the host-specific add-ins.

Another technical benefit of the AI agent and add-in integration approach is to reduce the workload cost of the AI agent ecosystem by offloading to the local-running add-ins. For example, the approach lowers GPU/AI-focused resource usages, and to move the computing resources to the host application directly when using the host-specific APIs.

Another technical benefit of the AI agent and add-in integration approach is to support users without knowledge of the add-ins and their rich capabilities, or any programming knowledge, to access the add-ins and their rich capabilities via an AI agent and model(s) within a host application.

These features among the overall process details described below in the disclosure provide a novel solution from both a technical and functional standpoint. These and other technical benefits of the techniques disclosed herein will be evident from the discussion of the example implementations that follow.

The term “plug-in” refers to a native or platform-specific extension. An extension is usually installed within the main program itself, often through built-in app stores or settings menus. An extension is often lightweight and less resource-intensive in comparison with a main program, and provides limited functionality. In the AI agent 128, “plugin” refers to API plugins, i.e., OpenAPI-based connectors to external services, used by the AI agent 128 to support natural language queries to access external systems (e.g., customer relationship management (CRM), enterprise resource planning (ERP), and the like).

The term “add-in” refers to a web-based extension built on a productivity software suite JavaScript API (e.g., Office.js API) for a host application. Such add-in runs in a browser sandbox inside the host application. For example, the productivity software suite add-ins are built using web technologies (e.g., HTML, CSS, JavaScript, and the like) and the JS API. While many APIs are shared across all Office® apps (e.g., Office.context, Office.ui), some APIs or features are specific to a particular host application. Example add-ins include mail merge automation in a word processing application, data visualization in Excel, and the like.

The term “host-application-specific” or “host-specific” refers to functionality, APIs, UI elements, or behaviors that are tailored to a particular host application, or across productivity software suite applications.

The term “programming interface”, in a broader sense, refers to the set of tools, libraries, and documentation provided by a software or system to help developers write code and interact with it. It provides developers with a well-defined way to use and interact with the software or system, allowing them to leverage its capabilities in their own applications.

Although various embodiments are described with respect to Office® add-ins, it is contemplated that the AI agent and add-in integration approach described herein may be used with add-ins of any office productivity software application/platform.

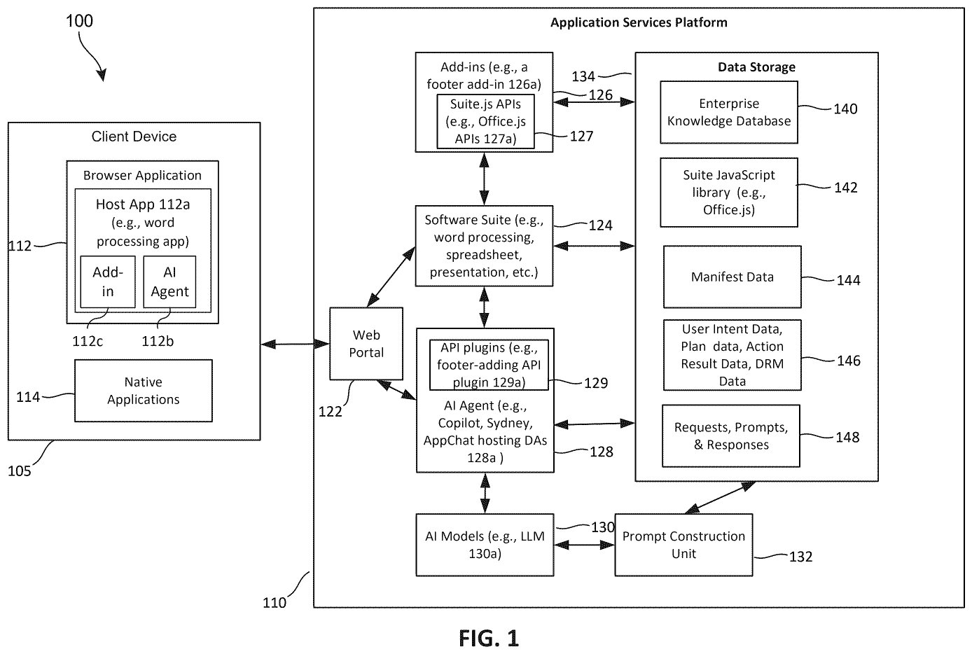

FIG. 1 is a diagram of an example computing environment 100 in which the techniques herein may be implemented. The example computing environment 100 includes a client device 105 and an application services platform 110. The application services platform 110 provides one or more cloud-based applications and/or provides services to support one or more web-enabled native applications on the client device 105. These applications may include but are not limited to email applications, presentation applications, website authoring applications, collaboration platforms, communications platforms, and/or other types of applications in which users may create, view, and/or modify content. In the implementation shown in FIG. 1, the application services platform 110 supports users to integrate host-application specific APIs of AI agents and add-ins, according to the techniques described herein. In one embodiment, the client device 105 and the application services platform 110 communicate with each other over a network (not shown) to implement the AI agent and add-in integration approach. In another embodiment, the application services platform 110 is independently implemented on the client device 105. The network may be a combination of one or more public and/or private networks and may be implemented at least in part by the Internet.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a single client device 105, other implementations may include a different number of client devices that utilize services provided by the application services platform 110.

The computing devices may include virtually any type of general- or specific-purpose computing devices with data processing units. For example, a computing device may be a user device such as a desktop computer, a laptop computer, a tablet computer, a display device, a camera, a printer, or a smartphone. Likewise, a computing device may also be a server device such as an application server computer, a virtual computing host computer, or a file server computer. Likewise, the computing device may be an example of any of the devices, a device within any of the distributed systems, illustrated in or referred to in any of the following figures, as discussed in greater detail below.

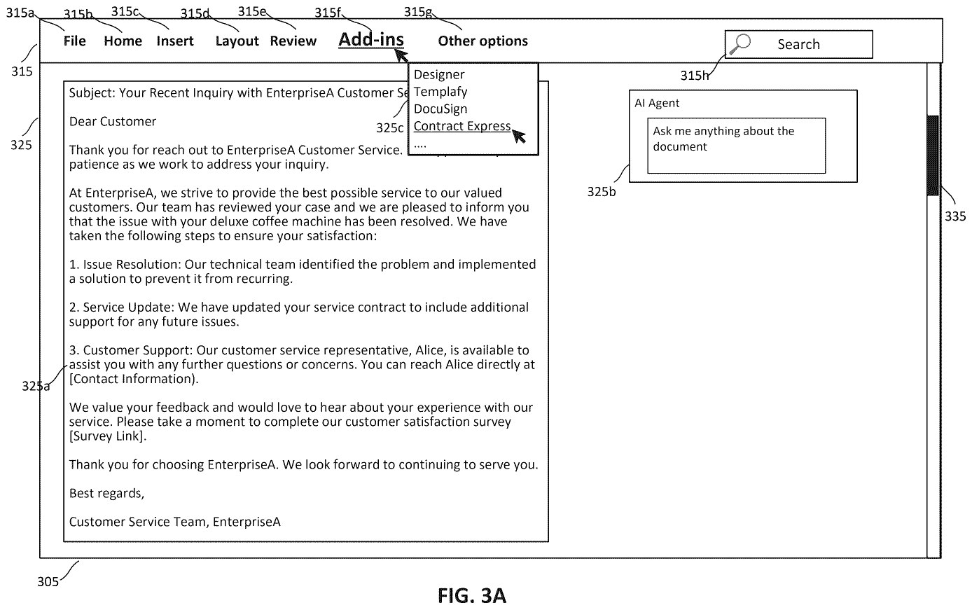

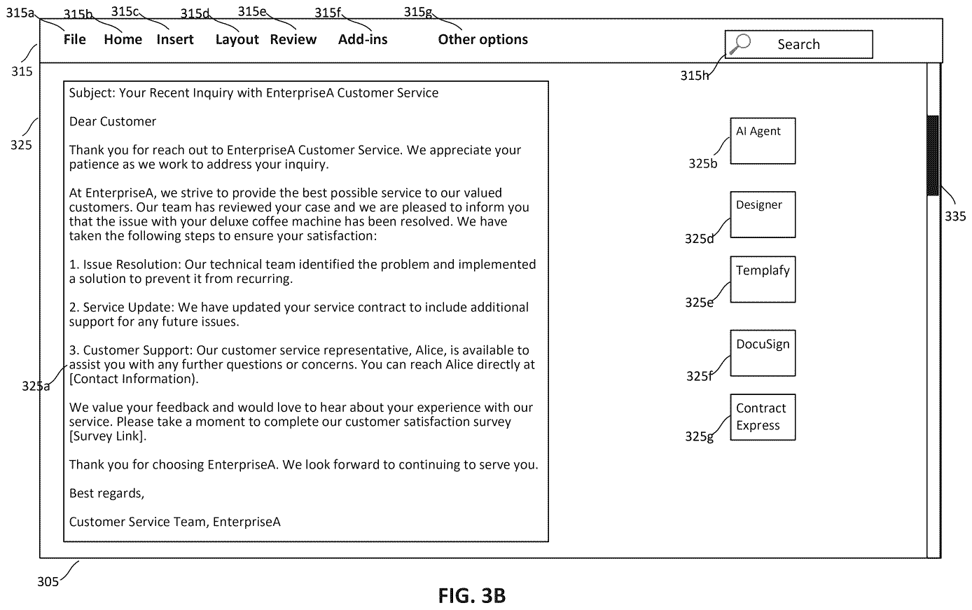

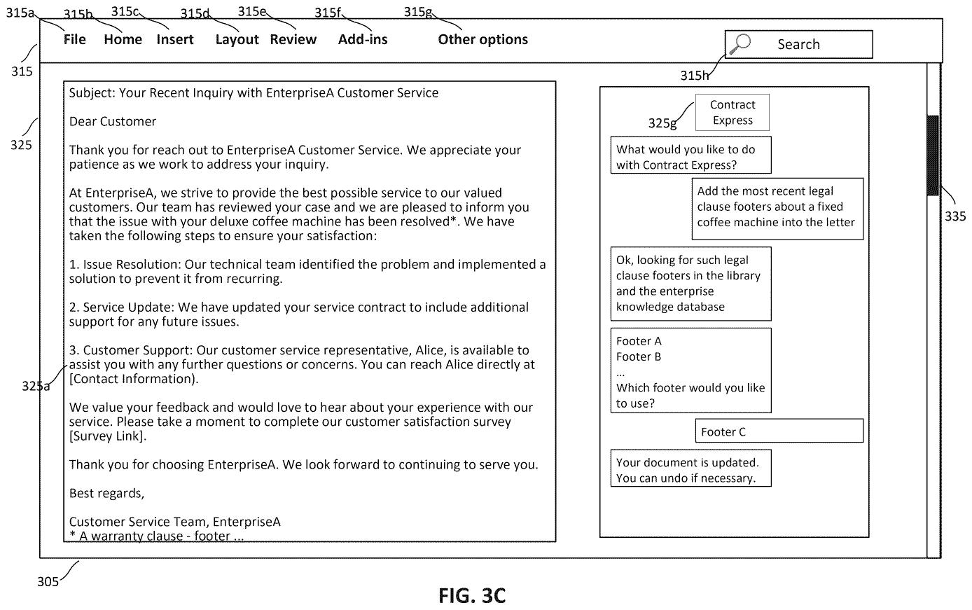

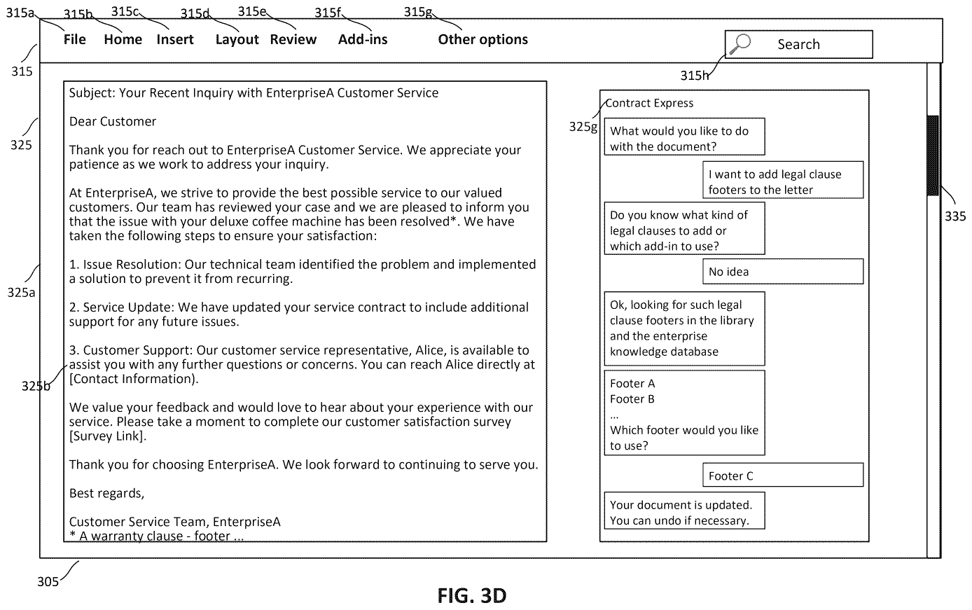

The client device 105 includes a native application 114 and a browser application 112. The native application 114 is a web-enabled native application, in some implementations, which enables users to create, view, and/or modify AI agents and/or add-ins via programming interfaces. The web-enabled native application utilizes services provided by the application services platform 110 including but not limited to creating, viewing, and/or modifying AI agents and/or add-ins via programming interfaces. The browser application 112 implements a user interface 305 shown in FIGS. 3A-3D in some implementations for accessing and viewing web-based content provided by the application services platform 110. In such implementations, the application services platform 110 implements one or more web applications, such as the browser application 112, that enables users to view, create, and/or modify AI agents and/or add-ins via programming inter-faces. For example, FIG. 1 shows a host application 112a accessed via the browser application 112, an AI agent 112b and an add-in 112c active within the host application 112a.

The application services platform 110 supports both the native application 114 and the browser application 112 in some implementations, and the users may choose which approach best suits their needs.

In one embodiment, the application services platform 110 includes web servers interacting with the host application 112a (e.g., a word processing application) on the client device 105, handling requests from clients (like web browsers) over HTTP or HTTPS, serving static content (such as HTML, CSS, and images), and processing dynamic content through server-side scripts or applications.

The web servers can route incoming requests to the appropriate handlers, manages security through SSL/TLS and access controls, and may also perform functions like load balancing, caching, compression, and logging. In modern applications, web servers can also act as API gateways, enabling communication between front-end clients and back-end services.

In another embodiment, the application services platform 110 includes a web portal 122 (e.g., Microsoft 365® app launcher), a software suite 124 (e.g., Microsoft 365®), add-ins 126, an AI agent 128 (e.g., Copilot®), a generative AI model 130 (e.g., a large language model, LLM), and a prompt construction unit 132. In other embodiments, the application services platform 110 also includes a data storage 134.

The web portal 122 is configured to receive requests from the native application 114 and/or the browser application 112 of the client device 105. The web portal 122 can check enterprise data (including enterprise employee data) or user-specific data for the user credentials before grating access to the application services platform 110. The requests may include but are not limited to requests to create, view, and/or modify content of interest (e.g., letters, resumes, summaries, translation, reports, articles, stories, blog posts, emails, movie scripts, image, music, video in various styles, video games, code snippets, and the like), and/or to generate DAs and/or add-ins. The web portal 122 also coordinates communication and exchange of data among components of the application services platform 110 as discussed in the examples which follow.

Having the single web portal 122 simplifies access to all the software suite applications, a user can log in once and easily switch between different programs of the software suite 124, so as to interact with content data of the application services platform 110. The web portal 122 provides a consistent user interface for all services of the application services platform 110. This makes it easier to navigate and find the tools a user need, regardless of the specific program. A user can manage the user's account settings, profile, and subscriptions from a single location within the web portal 122. The web portal 122 acts as a one-stop shop for accessing, managing, and using all the programs, although the programs probably do not share the same physical server or necessarily reside in the same cloud region. The application services platform 110 utilizes a distributed cloud infrastructure, meaning different services may be hosted in different physical locations or regions. For example, user emails might be hosted in a different physical location than the user's documents. This distributed approach allows the application services platform 110 to scale each service independently based on demand. It also offers redundancy, so if there is an issue in one location, other locations can handle the workload. If there is an outage in one location, other locations can keep services running.

The add-ins 126 are web-based extension built on a productivity software suite JavaScript API 127 (e.g., Office.js API 127a) for respective host applications. The add-ins 126 uses the suite JavaScript API 127 to interact with a digital content item opened in the host application. The digital content item is host-specific, such as a document, a spreadsheet, a presentation, a form, a diagram, a note, a website, an email, a calendar, a database, a whiteboard, and the like. For example, the Office.js API 127a allows the add-in to read content from the digital content item, to insert or update the digital content item, to apply formatting, to insert other digital content item(s)/object(s) (e.g., images, tables, and the like) into the digital content item, to navigate to specific parts of the digital content item, and the like. The Office.js API 127a includes a set of programming interfaces exposed by the Office.js library that developers use in their code. These are the actual objects, methods, events, and namespaces (e.g., Excel.Workbook, Office.context, Office.addin) a developer uses to manipulate an office productivity documents or respond to user actions. The Office.js API 127a functions like a toolkit after importing the Office.js library.

When an add-in 126 performs an action (e.g., inserting a legal clause footer, changing a format, or replacing content, and the like), those changes directly appear in the digital content item in real time, are rendered using the host application native user interface, and can be undone by the user (using an undo button). The user does not leave the digital content item, and the changes appear as if made directly.

A web-based add-in includes two core components: the manifest file and the web application. The manifest file is an XML or JSON document that describes the add-in's metadata, including its unique ID, version, name, permissions, and how it integrates into host application(s), such as through ribbon commands or task panes. The manifest file acts as a blueprint that the host application(s) uses to identify and load the add-in. The web application, built using standard web technologies (e.g., JavaScript), delivers the user interface and functional logic of the add-in. This web application is hosted on a web server and communicates with the host via the suite.js APIs 127 (e.g., Office.js APIs 127a) to read, write, and interact with content in the document. Each of the add-ins runs in a browser sandbox inside the respective host application. For web-based add-ins installed from an online application store or via custom XML or JSON files, their manifest files are cached locally on the client device 105. A sandbox is used to enhance security by providing a restricted environment to run important or potentially risky programs or code. By running the add-in in the browser sandbox, the system limits the add-in's access to critical resources and prevents the add-in from making unauthorized changes or installing malware.

In one implementation, a word processing add-in 126a for inserting legal-clause-footer is created using Office.js, by setting up a web-based project using JavaScript and referencing Office.js library. The add-in's settings and the host application are defined in a manifest file, which describes the add-in's metadata, UI elements (like task panes or command buttons), and required API sets. Using Office.js API, the add-in can interact with the host application, such as reading or writing content in a document. The add-in can be tested locally by sideloading it into the host application using tools, and eventually published it through an application store or an enterprise's admin center.

In one implementation, the AI agent 128 (e.g., Copilot®, Sydney®, AppChat®, and the like) includes/hosts one or more declarative agents (DAs) 128a each of which tailors the AI agent 128 for a corresponding add-in 126. The DAs 128a run on the same orchestrator, the AI models 130, and trusted AI services that power the AI agent 128. The core elements of a declarative agent app package include (1) an app manifest describing how the app is configured, including its capabilities, required resources, and other important attributes, (2) app icons for the declarative agents, (3) declarative agents manifest describing how the declarative agent is configured, including its required fields, capabilities, conversation starters, and actions, and (4) plugin manifest describing how a plugin is configured, including its required fields and capabilities.

Sydney®, Copilot®, and AppChat® are all AI-driven, yet serving distinct roles. Sydney® is a web-based conversational AI that assists with general queries and web searches. Copilot® is a broader AI assistant, embedded directly into host applications, helping users write, analyze, and automate tasks using both GPT-4 and organizational data. AppChat®, on the other hand, enables AI-functionality tailored to an application it is running in (e.g., a host application), as well as to chat directly with applications (e.g., add-ins) using natural language, allowing users to control or retrieve information from these apps through chat, powered by AI.

The Office add-in-only manifest is a traditional XML-based file used to define metadata, permissions, and capabilities for Office add-ins. In contrast, the unified manifest is a newer, more comprehensive format designed to support both Office add-ins and Microsoft Teams® apps within a single manifest, enabling developers to code solutions that work seamlessly across both platforms. In one implementation, to create a DA in the AI agent 128, the agent's behavior, goals, and capabilities are defined using a structured JSON configuration file. This file includes natural language instructions, input and output schemas, and optional links to API plugins that enable the agent to perform specific tasks by calling external services.

The DAs 128a operate within the productivity software suite, and respond to user prompts by executing predefined actions or workflows. The DAs 128a can be built and tested using tools, and deployed within a tenant to make it available to users as part of the AI agent experience. Rather than connecting to a REST endpoint, the AI agent and add-in integration approach connects a DA with an action/function mapped with a user query to a host-specific add-in supporting the action/function. The user query is saved in the data storage 134 as the requests, prompts, and responses 148. In one implementation, the user intent/query is mapped by the AI agent 128 to the intents specified in the DA manifest that further maps to an add-in manifest. This extends AI agent's abilities into add-in capabilities driven by natural language and connected data.

The AI agent and add-in integration approach enables DAs to use API plugins to call add-in functions by introducing action/function definitions into a set of DA, plugin, and add-in manifests, thereby supporting calling that plugin capability via a host application which in turn calls action(s)/function(s) in an add-in corresponding to a user query. For example, Table 1 lists an existing DA manifest, while Table 2 lists a DA manifest declarativeAgent.json introduced with the action/function definitions as “id”: “repairsWordLocalAction”, “file”: “word-local-actions.json”, and “scopes”: [“document” ].

TABLE 1
{
“$schema”:
“https://aka.ms/json-schemas/copilot/declarative-agent/v1.0/schema.json”,
“version”: “v1.0”,
“name”: “M365 Helper Agent”,
“description”: “Declarative agent created with Teams Toolkit”,
“instructions”: “$[file(‘instruction.txt’)]”,
“conversation_starters”: [
“title”: “Getting Started”,
“text”: “How can I help you today?”
}
1,
“capabilities”:[
{
}
“name”: “WebSearch”
“actions”: [
{
“id”: “repairsPlugin”,
“file”: “repairshub-apiplugin.json”
}
]
}

TABLE 2
{ }
“name”: “Repairs GPT”,
“description”: “A GPT for fetching repair information”,
“instructions”: “<instructions here>”
“conversation_starters”: [{
“title”: “My Open Repairs”,
“text”: “What open repairs are assigned to me?”
“actions”: [{
“id”: “repairsPlugin”,
“file”: “plugin.json”
“id”: “repairs WordLocalAction”
“file”: “word-local-actions.json”,
“scopes”: [“document”]
}
]
}

The API plugins according to the AI agent and add-in integration approach are enabled to call add-in functions. The API plugin manifests are written with parameter binding, response expected, and other standard OpenAPI components, yet excluding REST verbs in their descriptions of callable endpoints. An API plugin manifest based on the OpenAPI standard includes several key components to define and document how the API works. It starts with the openapi version, followed by info for metadata such as the title, version, and description. The servers section lists the base URL(s) for API calls. The paths section is central, and it defines endpoints along with their supported HTTP methods (e.g., GET, POST, and the like). The paths section includes parameter binding for query, path, header, or body parameters, specifying where each parameter appears and whether it is required. Each endpoint also defines expected responses under the responses field, outlining status codes (like 200, 400, 500), content types (e.g., application/json), and schemas describing the response structure. The components section provides reusable definitions for parameters, schemas, and responses, while the security section outlines authentication mechanisms.

The AI agent and add-in integration approach also requires add-in developers to add, in the corresponding add-in, a blob in json format that is passed in as the argument, parameters bound by the definition in the DA manifest, thereby enabling the API call flow from the AI agent 128 via an API plugin in a DA to the add-in.

The AI agent 128 and DAs 128a serve different purposes within the AI ecosystem. DAs 128a are designed for developers to define agent behaviors using a schema-based, rule-driven approach, making them ideal for backend automation, workflow orchestration, and integration with APIs or business logic. In contrast, the AI agent 128 is powered by the AI models 130 (e.g., LLMs) and focus on enhancing user productivity within applications like Microsoft 365®, GitHub®, Teams®, and the like by providing contextual assistance, generating content, and automating tasks based on user input. While the DAs 128a prioritize structured, predictable execution, the AI agent 128 emphasizes natural language understanding and adaptability within user-facing scenarios.

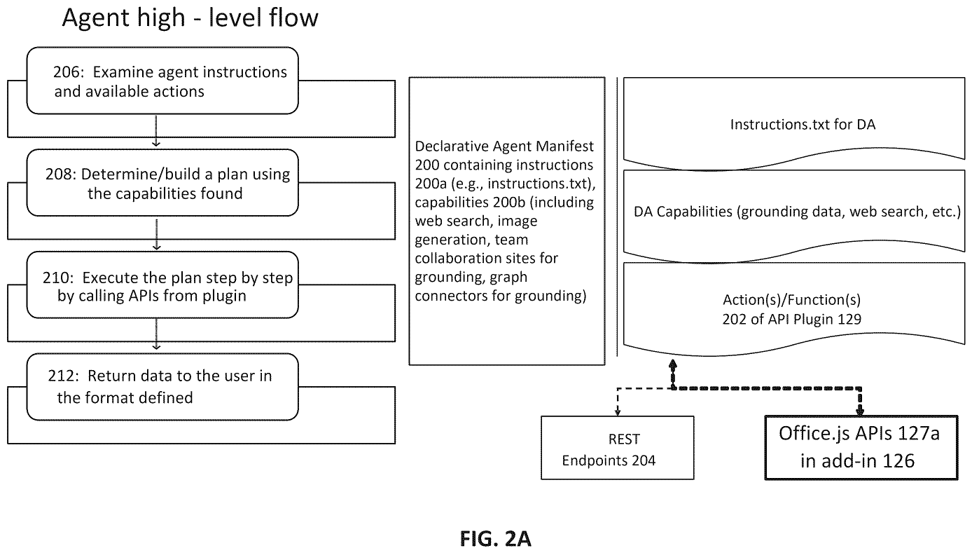

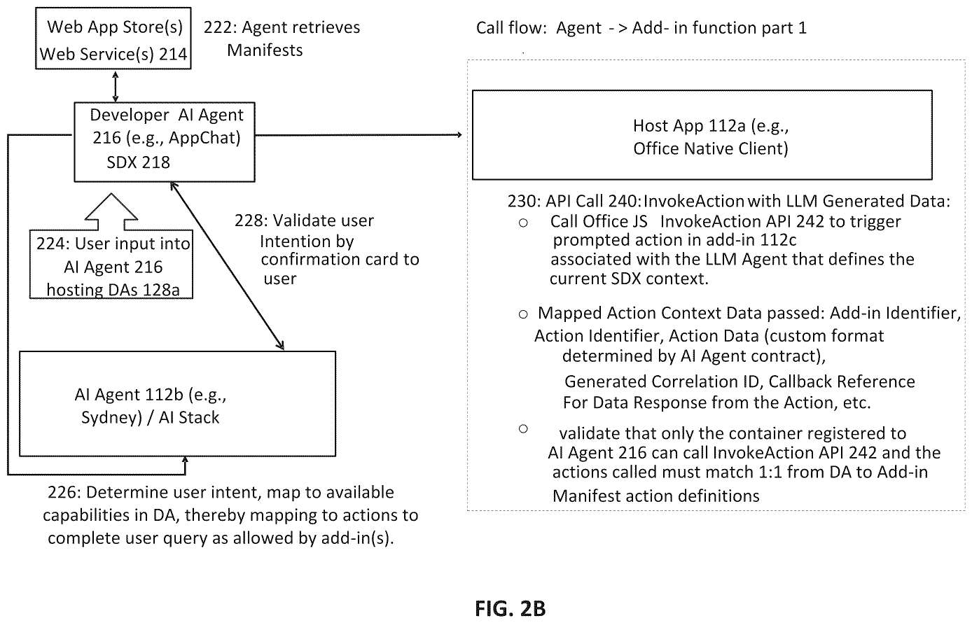

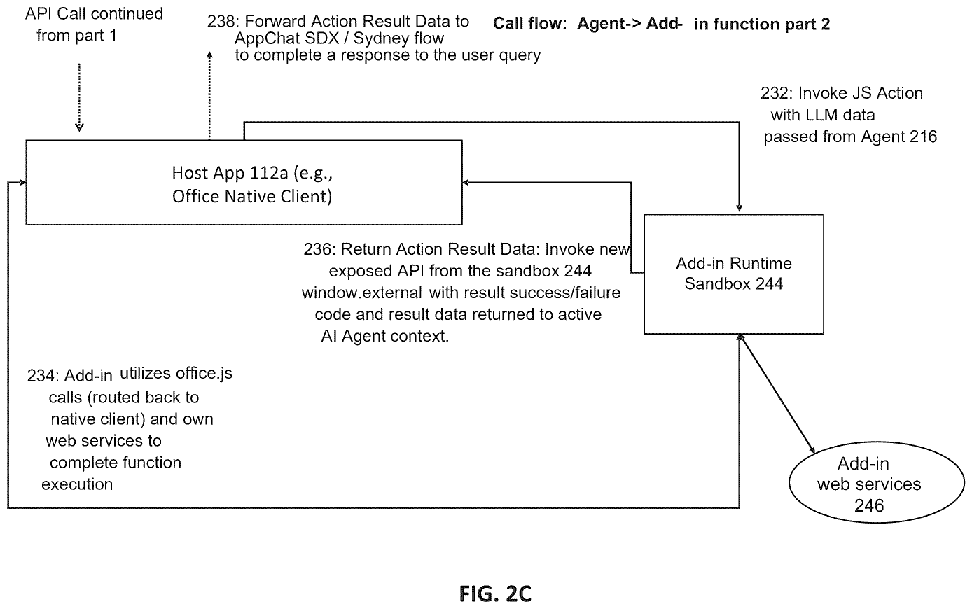

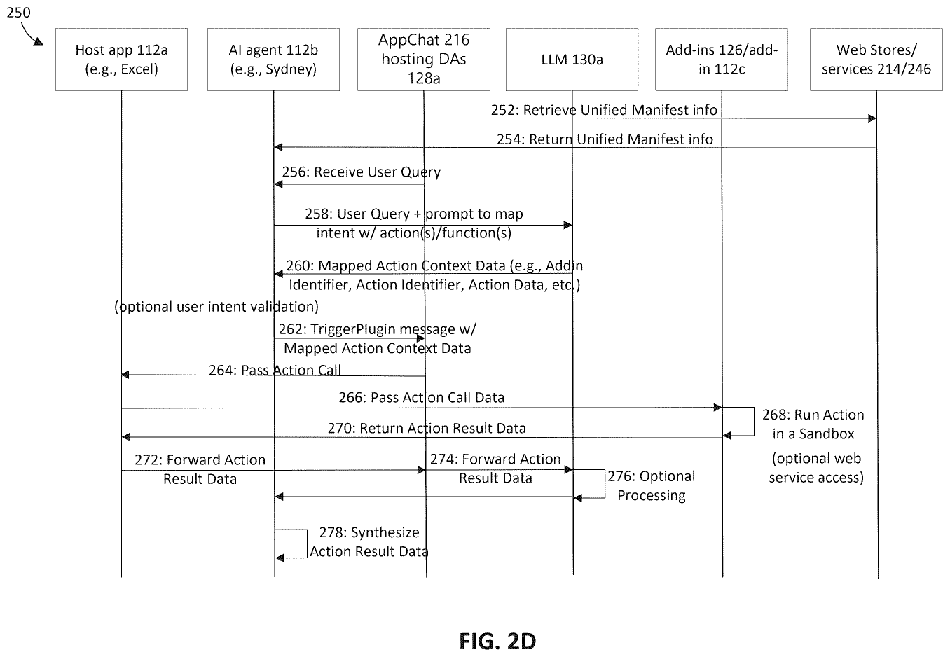

In one embodiment, the AI agent 128 includes generative models trained to generate content (e.g., textual, spreadsheet, chart, report, audio, image, video, and the like) in response to prompts input by a user via the native application 114 or via the browser application 112. For instance, the AI agent 128 uses generative models including a LLM 130a in some implementations as depicted in FIGS. 2A-2D. Examples of such models include but are not limited to a Generative Pre-trained Transformer 3 (GPT-3), GPT-4 model. For instance, the generative models are implemented using a multimodal model (e.g., GPT-4o) in some implementations. Developing an AI model capable of generating content of interest (e.g., mapped action context data) requires training on large and diverse datasets, thereby ensuring that the generated content are relevant and accurately reflect the content of interest. Other implementations may utilize machine learning models or other generative models to generate the mapped action context data according to contextual features of the content and/or preferences of a user.

API plugins 129 enhance the functionality of the DAs 128a by enabling interactions with external systems and APIs, thereby allowing the DAs 128a to perform actions like querying or updating data through APIs described by OpenAPI specifications. The key components of an API plugin 129 include the OpenAPI specification, which defines available endpoints, supported HTTP methods, required parameters, request and response formats, and authentication details. Data binding is crucial as it maps user inputs to API parameters, ensuring the correct data is passed during runtime. The format component ensures that requests and responses adhere to specified schemas (e.g., JSON), maintaining compatibility between systems. Required parameters are explicitly defined in the OpenAPI specification to ensure successful API calls, and can include headers, path variables, or query strings. These components work together to enable seamless, secure, and intelligent interactions between the AI agent 128 and external services.

The AI agent and add-in integration approach expands the capabilities of the DAs 128a by selectively connecting to the add-ins 126 based on a user query, as later explained in detail in conjunction with FIG. 2A. In one implementation, the API plugins 129 are managed within the Copilot Studio® environment, where they are configured and associated with specific DAs 128a.

The prompt construction unit 132 is responsible for creating and refining prompts to interact effectively with the AI models 130. This involves designing input instructions that guide the AI models 130 to produce accurate and contextually relevant outputs. The key tasks of the prompt construction unit 132 in the DA and add-in unifying approach include constructing prompts to the AI models 130 (e.g., a LLM 130a) to determine, based on a user query and unified manifest information, a plan of executing actions upon a host-specific digital content item in a host application by one or more corresponding add-ins. The prompts are saved in the data storage 134 as the requests, prompts, and responses 148.

The data storage 134 includes an enterprise knowledge database 140, a suite JavaScript library 142, manifest data 144, user intent data, plan data, action result data, DRM data 146, requests, prompts, and responses 148, and the like. The web portal 122 is configured to receive requests from the native application 114 and/or the browser application 112 of the client device 105. The enterprise knowledge database 140 is a centralized repository that organizes and manages an organization's internal knowledge, such as documents, emails, chats, business data, and the like. It retrieves relevant information across the productivity software applications and platforms, to provide contextual insights. By tapping into this structured knowledge base, the AI agent 128 enhances productivity by enabling users to quickly access and interact with organizational knowledge through natural language queries, helping streamline tasks, decision-making, and collaboration.

The suite JavaScript library 142 includes the actual JavaScript file (e.g., office.js) that gets loaded into an add-in's HTML to give access to host application APIs. It contains the definitions and objects needed to interact with the host applications like Excel, Word, Outlook, etc., and is required in every suite add-in project to access the suite functionalities (like reading a document, sending an email, integrating with external services, and the like). Developers uses the suite JavaScript library 142 to create web-based add-ins 126. For instance, in PowerPoint add-ins, developers can interact with objects to manipulate slide content programmatically. The details of the manifest data 144, the user intent data, plan data, action result data, DRM data 146, and the requests, prompts, and responses 148 are provided in conjunction with FIGS. 2A-2D below. While most data interactions remain within the data storage 134 trust boundary, some scenarios, such as those involving third-party plugins, may transmit data outside this boundary.

FIG. 2A is a high-level flow diagram for integrating an AI agent with host-application-specific add-ins from the perspective of the AI agent of the system of FIG. 1. FIG. 2A shows a declarative agent manifest 200 contains instructions 200a (e.g., instructions.txt listed in Table 3), and capabilities 200b (including web search, image generation, team collaboration sites (e.g., SharePoint) for grounding, graph connectors for grounding, and the like). The AI agent description may start from a base query, and grows by add-in actions/functions. For example, in response to a user query to add a legal-clause-footer in a word processing document, additional DA instructions (e.g., “title”: “Add footer (for word)”, “text”: “Add a footer with message ‘Hello Agent!’. Tell me how long it took in seconds.”) are added to a pre-formed query (or a base query for all agents) as the updated DA instructions in Table 1 to help shape the DA 128a.

```
TABLE 3
{
  “name”: “Add-in Demo Skill Agent”,
  “description”: “You are an agent for working with add-in. You can work with any cells, not
only well formatted table. ”,
  “instructions”: “You are an agent for working with add-in. You can work with any cells,
not only well formatted table. ”,
  “conversation_starters”: [
    {
      “title”: “Change cell color (for excel)”,
      “text”: “Change the cell below A2 to the color of grass. Tell me how long it took in
seconds.”
    },
    {
      “title”: “Add footer (for word)”,
      “text”: “Add a footer with message ‘Hello Agent!’. Tell me how long it took in seconds.”
    },
    {
      “title”: “Add text to slide (for powerpoint)”,
      “text”: “Please add text ‘Hello PPT!’ to the slide. Tell me how long it took in seconds.”
    }
  ],
  “actions”: [
    {
      “id”: “alchemyPlugin”,
      “file”: “alchemy-plugin.json”
    }
  ]
}
```

According to the DA manifest 200, the DAs 128a can perform the capabilities 200b such as web searches using Bing, with options to scope searches to specific public websites, providing users with relevant and up-to-date information. These DAs 128a can also access and utilize content from team collaboration platforms, grounding responses in organizational knowledge that users have permission to access. Additionally, connectors/API endpoints enable the DAs 128a to incorporate data from external sources, allowing for more comprehensive and context-aware interactions. Through these integrations, the DAs 128a offer tailored assistance, streamlining workflows and improving collaboration within host application environments.

The DA instructions 200a assist the AI agent 128 to respond to the user query. A footer adding API plugin 129a corresponding to a legal-clause-footer add-in 126a for a word processing application is mapped, since the footer adding API plugin 129a also has AI agent descriptions for each function/action (e.g., action(s)/function(2) 202 of an API plugin 129) that is named and is part of how the execution flow is determined when trying to complete the user query. For example, the AI agent description is added with action/function definitions, such as a legal-clause-footer definition listed in Table 4.

```
TABLE 4
“name”: “addfooter”,
  “description”: “Action addfooter: Takes in the desired document footer as a string.”,
  “parameters”: {
    “type”: “object”,
    “properties”: {
        “Footer”: {
          “type”: “string”,
          “description”: “A string to be added as a footer.”,
          “default” : “this is the default footer value v2”
        }
      },
      “required”: [“Footer”]
  },
  “states”: {
    “reasoning”: {
      “description”: “\n# `addfooter(Footer: str = ‘this is the default footer value’) -
> str` Action addfooter: Takes in the desired document footer as a string.”,
      “instructions”: “\n- Decide whether to invoke `addfooter(Footer: str = ‘this is the default
footer value’)`”
    }
```

Referring back to the legal-clause-footer inserting scenario and FIG. 2A, the AI agent 128 examines available DA instructions 200a and actions/function 202 in step 206, to determine/build a plan for inserting legal-clause-footer using the DA capabilities 200b found to respond to the user query in step 208. The plan can be saved in the data storage 134 as a part of the user intent data, plan data, action result data, DRM data 146. For this simple case, the AI agent 128 can map the legal-clause-footer function from a list in the manifest package based on index information. However, for a complicate user query, the AI agent 128 can involve the LLM 130a to determine an execution plan, and then maps the actions/functions accordingly.

The AI agent 128 executes the plan step by step by calling corresponding API plugin(s) and the legal-clause-footer add-in 126a for a word processing application in step 210, and returns data to the user in a defined format in step 212. In short, user query is mapped by the AI agent 128 to the intents specified in the DA manifest that further maps to an add-in manifest (e.g., relevant code listed in Table 5).

TABLE 5

```
{
    “id”: “addfooter”,
    “type”: “executeDataFunction”
  },
...
```

Rather than connecting to limiting REST endpoints 204, the AI agent and add-in integration approach selectively connects correspond API plugin(s) 129 to Office.js APIs 127a in the legal-clause-footer add-in 126a among thousands of rich productivity software suite add-ins and related capabilities via an AI conversational interface.

Planning via the data of available DA instructions 200a and actions/function 202, the AI agent 128 can access the capabilities among thousands of rich productivity software suite add-ins. The legal-clause-footer adding scenario is used to simplify this discussion. As the user query gets more complicated, more actions/functions from one or more add-ins are involved as planned by the AI agent 128, the AI agent and add-in integration approach becomes very powerful. For example, the user queries a 2-week sale trip in spring 2025, including existing/potential client lists, talking points, flight tickets, rental cars, hostel reservations, and a packing list.

The possibility and/or validity of user queries is limited to the available DA instructions 200a which is in turn limited to a user's rights to access document(s) in the host application 112a, and rights to access the add-ins 126. The users' access right data is saved in the data storage 134 as a part of the user intent data, plan data, action result data, DRM data 146.

The AI agent and add-in integration approach allows a user to seamlessly access specialized tools, services, and workflows of thousands of rich third-party add-ins within the productivity software applications directly via the AI agent 128 in a user interface within a productivity software application. These add-ins offer capabilities such as data visualization, document automation, project management, CRM integration, e-signatures, grammar checking, financial modeling, and more as actions/function. The add-in access via the AI agent 128 save time, reduce app switching, and improve workflow efficiency across various actions/functions.

In addition, the add-in access via the AI agent 128 and corresponding API plugins 129 streamline tasks without switching between platforms. These add-ins often connect to external systems or cloud services, allowing users to retrieve, process, and submit data across platforms in real-time, while adhering to enterprise security and compliance standards.

Popular third-party productivity software suite add-ins include tools like Grammarly®, Adobe Acrobat®, DocuSign®, Trello®, Salesforce®, and the like, each offering unique benefits that enhance productivity within productivity software applications. Grammarly® helps users write with clarity and professionalism by offering advanced grammar and style suggestions directly in Word® and Outlook®. Adobe Acrobat® enables seamless PDF editing, creation, and conversion within the productivity software suite, streamlining document workflows. DocuSign® simplifies the process of signing and sending documents securely without leaving Office apps. Trello integrates task and project management features into an email application, allowing users to create and manage cards from emails. Salesforce add-ins connect the productivity software suite with CRM data, enabling users to track emails and appointments and manage customer information in real time.

FIGS. 2B-2C is an API call flow diagram for integrating the AI agent with the host-application-specific add-ins of the system of FIG. 1. The API call flow starts with step 222 in FIG. 2B, during which a developer AI agent 216 (e.g., AppChat®) under the Software Development Kit Extension (SDX) framework 218 retrieves unified manifests from web app store(s) and/or web service(s) 214 and saves the information into a manifest package. These manifests contain action/function definitions in both the DA and Add-in json files with a 1:1 mapping and user intent information. The manifests are saved in the data storage 134 as a part of the manifest data 144.

As mentioned, AppChat® is a developer-focused conversational interface for a developer to chat directly with applications using natural language. The SDX framework 218 is a framework designed to extend the AI agent 128 with custom capabilities, allowing developers to integrate their own business data, logic, and workflows. The core components of Copilot SDX® include DAs, which define how the AI agent 128 should interact with users and services; plugins, which connect the AI agent 128 to external APIs through OpenAPI specifications; and data grounding, which enables the AI agent 128 to access enterprise content securely using connectors/API endpoints and other data sources. It also supports web search integration, image generation, and team collaboration contexts, enriching user prompts with real-time, contextual data. Together, these components provide a scalable, secure way for organizations to tailor the AI agent 128 to their specific needs and systems.

The possibility and/or validity of user queries is limited to the available DA instructions 200a which is in turn limited to a user's rights to access document(s) in the host application 112a, and rights to access the add-ins 126.

In one implementation, the developer AI agent 216 retrieves unified add-in manifests from all available web app stores and/or web services 214 to set up a comprehensive add-in action/function database for the system to store in the data storage 134 to share by all users. The system also real-time and/or periodically updates the add-in action/function database when new add-ins are registered and/or published via the web app stores and/or web services 214.

In another implementation, the developer AI agent 216 retrieves add-in manifests from some of the web app stores and/or web services 214 accessible for a user to set up an individual add-in action/function database. Alternatively, the individual add-in action/function data is used to build the comprehensive add-in action/function database, yet tagged with individual ID as accessible for the user.

In yet another implementation, the developer AI agent 216 retrieves add-in manifests from some of the web app stores and/or web services 214 in response to a user query. The query add-in action/function data is used to build the comprehensive add-in action/function database, yet tagged with individual ID as accessible for the user as validation.

In step 224, a user inputs a query in natural language in a selected context of the DA 128a. In step 226, the user's intent is determined and mapped to intent(s) specified in the DA manifest 200 by the AI agent 112b (e.g., Sydney®) within the browser application 112, thereby mapping the user query to action(s)/functions of the add-in 112c. In step 228, the AI agent 112b validates the user intent by sending a confirmation card to the user, and then gets the confirmation card for the user in the loop.

In step 230, the host application 112a validates that the API call 240 as coming from a container registered to the AI agent 128 and that the action requested is defined in the add-in manifest. Only the container registered to the AI agent 128 can call the InvokeAction API 242 and the action(s)/function(s) called must match 1:1 from DA to Add-in manifest action definitions.

In some implementations, the validation is part of digital rights management (DRM) to control how sensitive and/or copy-righted content is accessed, used, and distributed. When it comes to third-party add-ins, DRM ensures that the add-ins are accessible for authorized users. In terms of the documents in the host applications protected by DRM, an unauthorized user is restricted from reading or modifying its content with add-ins. This ensures that sensitive and/or copy-righted information remains secure, and that third-party tools cannot bypass enterprise data protection and data privacy policies, thereby maintaining compliance with organizational and regulatory requirements. The DRM data is saved in the data storage 134 as a part of the user intent data, plan data, action result data, DRM data 146.

After validation, the AI agent 112b calls a JS invokeAction API 242 in the host application 112a with LLM Generated Data listed in FIG. 2B, to trigger prompted action(s)/function(s) in the add-in 112c associated with the AI agent 112b (e.g., the developer AI agent 216) that defines the current SDX context. The LLM Generated Data listed in FIG. 2B (“mapped action context data”) includes an add-in identifier, an action identifier, action data (e.g., a custom format determined by an AI Agent contract), a correlation identifier, a callback reference for a data response from the action, and the like. An AI Agent contract is a predefined set of rules and protocols that govern how an AI agent interacts with other systems, users, or agents to perform tasks autonomously and reliably. The InvokeAction API 242 is part of the JavaScript APIs for the productivity software suite add-ins, specifically used to programmatically perform actions within the productivity software suite content items.

The API call flow continues to step 232 in FIG. 2C, during which the host application 112a passed validation that this API call 240 is legitimate, and invokes the action(s)/function(s) by calling the LLM Generated Data defined by the DA 128a and sent from the AI agent 112b into a browser sandbox (e.g., an add-in runtime sandbox 244).

In step 234, the add-in 112c can run anything it has defined as the result of the action(s)/function(s) including calling data back from the host application, calling one or more web services 246 or anything within the scope of the add-in runtime sandbox 244. The add-in runtime sandbox 244 is designed specifically to contain and restrict the execution of the add-ins 126 (e.g., the add-in 112c). The add-in runtime sandbox 244 ensures that add-ins running in a browser-like environment operate within strict permissions and cannot access sensitive resources or perform unauthorized actions.

When the add-in 112c invokes an Office.js API, for example, to read or write data to a document, it typically provides a callback function as part of the API call. The host application 112a processes the request and, once the operation is complete, the host application 112a calls the provided callback function with the result, which may include success status, any returned data, or error information. This design allows the add-in 112c to remain responsive and continue executing other tasks while waiting for the host application 112a to complete the requested action. The callback mechanism is fundamental to the event-driven architecture of the add-ins and is essential for handling user actions, document updates, and other asynchronous events efficiently. For instance, the add-in 112c utilizes office.js calls (routed back to the host application 112a and its own web services 246 to complete action/function execution. The add-in 112c completes any office.js calls into the host application 112a to do any sub-action(s)/sub-function(s) defined for the action(s)/function(s).

For example, the user request a project with a list of questions in a table for the AI agent 128 to fill in answers to the questions. The AI agent 128 works with the LLM 130a to develop a plan with actions and sub-actions to call different add-ins to consult various web services for different answers to the questions, and updates the table sequentially on the under interface 305 of the client device 105.

In step 236, once the add-in 112c is done executing, it returns via the callback mechanism from invocation with a success/failure code and result data to be consumed by the caller of the InvokeAction API 242, e.g., the AI agent 112b. The callback mechanism enables asynchronous communication between the host application 112a and the add-in 112c. In one implementation, the add-in 112c invokes a new exposed API from the sandbox 244 (e.g., a client sandbox window.external) with a result success/failure code and result data returned to the context of the active AI agent 112b.

For instance, window.external is a JavaScript object that allows web pages or scripts running inside a browser or a host application to interact with external components, usually COM (component object model) objects or host application functions exposed to the web page. In this case, window.external is used by the productivity software suite add-ins to interact with the host application 112a. When an add-in is opened in the sandbox 244, such as in a protected view, access to window.external is restricted or blocked entirely to enhance security. This means that sandboxed add-ins running in this environment cannot call host-specific APIs through window.external, limiting their ability to perform actions like manipulating the document, accessing user data, or invoking host-specific functions. For example, Office hosts the executing add-in code in the sandbox 244 (in the host application 112a that manifests itself as a separate process hosting the browser control with a COM interface allowing for cross-process communication). In the web application 112, the add-in 112c manifests itself as an independent IFrame hosted in a frame of the host application 112a. A host application COM interface is a standardized way for software components to communicate with each other in a Windows environment, allowing an application (the host) to expose its internal objects, functions, and data to other programs or scripts.

In step 238, the host application 112a forwards the data back to the AI Agent 112b (e.g., Sydney®) in FIG. 2B. The AI agent 112b confirms the action(s)/function(s) is complete and prepares a response to the user query with or without further LLM assistance. The AI agent 112b then visually presents the response to the user. The response is saved in the data storage 134 as the requests, prompts, and responses 148.

FIG. 2D is a sequence diagram 250 of applying the API call flow depicted in FIGS. 2B-2C to a different scenario, i.e., fill color in a spreadsheet cell. In steps 252-254, the AI agent 112b retrieves and receives unified manifest information from web app stores and/or web services 214, and saves the information into a manifest package. The unified manifest information contains action definitions in both the DA and add-in json with a 1:1 mapping as well as corresponding user intent information.

A user submits a query to fill a green color in a spreadsheet cell via the AI agent 216 that passes the query to the AI agent 112b in step 256. The AI agent 112b sends the user query and a prompt to the LLM 130a in step 258, and the LLM 130a maps the user intent with a cell-color-filling function, and returns to the AI agent 112b mapped action context data (e.g., an add-in identifier, an action identifier, action data, a correlation identifier, a callback reference for a data response from the action, and the like) in step 260.

Optionally, the AI agent 112b sends to the developer AI agent 216 a message with a Confirmation Dialog, i.e., a description of the action extracted from the action definition and synthesized parameter values. The user inspects the parameters and confirms the execution. After the user confirmation, the developer AI agent 216 sends back to the AI agent 112b the confirmation message. After verifying the confirmation, the AI agent 112b sends to the developer AI agent 216 a TriggerPlugin message with the mapped action context data to call a API plugin for executing the function in step 262, corresponding to InvokeAction API in FIGS. 2B-2C. The developer AI agent 216 passes such call to the host application 112a via the Office.js API 127a in step 264, and the host application 112a passes the call to the add-in 112c in step 266. The add-in 112c runs the action in a sandbox in step 268 by modifying the canvas using the “fillcolor” function, and returns back to the host application 112a action result data in plain text in step 270. The action result data can be saved in the data storage 134 as a part of the user intent data, plan data, action result data, DRM data 146.

When the add-in 112c performs the action, the relevant changes directly appear in the document in real time, as rendered using the host application 112a native user interface, and can be undone by the user (using an undo button).

When the user query involves multiple calls/actions, or the action has results that need to be processed by the LLM 130a, the host application 112a forwards the action result data to the developer AI agent 216 in step 272. The developer AI agent 216 forwards the action result data to the LLM 130a in step 274. After the optional processing (e.g., consolidating and/or removing the action result data from the calls/actions), the LLM 130a sends the processed action result data to the AI agent 112b in step 276. The AI agent 112b uses the processed action result data synthesize a final user message with reference in step 278 which is then rendered to the user.

The TriggerPlugin message in FIG. 2D and the InvokeAction API call in FIG. 2B are both mechanisms used within the productivity software suite add-ins ecosystem to execute defined commands or actions, but they serve different purposes and operate in distinct contexts. A TriggerPlugin message is primarily used in declarative environments, such as an Excel® cell or an Outlook® actionable message or adaptive card, where a user interaction, like clicking a button, can trigger a plugin command that has been registered in the add-in manifest. It is a manifest-based instruction that tells the host application to launch a specific command or open a task pane, often without needing custom JavaScript execution at that moment.

In contrast, an InvokeAction call, commonly implemented via Office.actions.invoke, is a programmatic API used within Office.js-based add-ins (e.g., for Word, Excel, PowerPoint) that allows developers to dynamically call named functions defined in their JavaScript code. This approach is more flexible and suited for complex scenarios where the developer needs to perform logic, manipulate the document, or update the UI based on runtime data. While TriggerPlugin is ideal for lightweight, UI-driven commands especially in email and messaging contexts, InvokeAction is better suited for full-featured task pane add-ins that require richer user interaction and document manipulation capabilities. Both serve as bridges between user actions and add-in functionality, yet they differ in scope, flexibility, and the environments in which they are better utilized.

All the above-discussed requests, the enterprise knowledge database 140, the suite JavaScript library 142, the manifest data 144, the user intent data, plan data, action result data, DRM data 146, the requests, prompts, and responses 148, can be stored in the data storage 134. The data storage 134 can be physical and/or virtual, depending on the entity's needs and IT infrastructure. Examples of physical enterprise data storage systems include network-attached storage (NAS), storage area network (SAN), direct-attached storage (DAS), tape libraries, hybrid storage arrays, object storage, and the like. Examples of virtual enterprise data storage systems include virtual SAN (vSAN), software-defined storage (SDS), cloud storage, hyper-converged Infrastructure (HCI), network virtualization and software-defined networking (SDN), container storage, and the like.

FIGS. 3A-3D are example user interfaces of the system for integrating an AI agent with host-application-specific add-ins that implement the techniques described herein. The example user interface shown in FIGS. 3A-3D is a user interface of a word processing application in a web browser (e.g., the browser application 112), such as but not limited to Microsoft Edge®. However, the techniques herein for integrating AI agents with host-application-specific add-ins are not limited to use in the word processing application and may be used for other types of applications including but not limited to presentation applications, website authoring applications, collaboration platforms, communications platforms, and/or other types of applications in which users create, call, and/or modify host-specific add-ins.

FIG. 3A shows an example of the user interface 305 of an email application in which the user is interacting with a programmatic interface to call one or more actions/functions in add-ins via a DA plugin based on a user query to an AI agent within a host application active in the browser application 112. The user interface 305 includes a control pane 315, a content pane 325 and a scrollbar 335.

In some implementations, the control pane 315 includes a File button 315a, a Home button 315b, an Insert button 315c, a Layout button 315d, a Review button 315e, an Add-in button 315f, an Other Options button 315g, and a search field 315h for triggering the respective functions in the word processing application.

In FIG. 3A, the content pane 325 shows a document 325a (e.g., a customer service letter) and an AI agent 325b with a chat box displaying “Ask me anything about the document.” When a user already knows which add-in to use, the user clicks the Add-in button 315f, and the content pane 325 shows an Add-in dropdown menu 325c with options of Designer, Templafy, DocuSign, Contract Express, and the like that the user already has rights to access.

In another implementation as shown in FIG. 3B, instead of the Add-in dropdown menu 325c, the content pane 325 shows multiple add-in agents underneath the AI agent 325b. Each of a Designer agent 325d, a Templafy agent 325e, a DocuSign agent 325f, a Contract Express agent 325g, and the like is especially configured to handle prompts that require accessing the specific add-in associated that add-in agent that the user already has rights to access.

Upon a user selection of the option of Contract Express in FIG. 3A or the Contract Express agent 325g in FIG. 3B, a chat box displaying the icon 325g of Contract Express in FIG. 3C, and the AI agent 128 interacts with the add-in Contract Express according to the above-discussed implementations. As shown in the AI chat box 325b, the AI agent 128 first asks the user what the user would like to do with Contract Express, and receives a query of “adding the most recent legal clause footers about a fixed coffee machine into the letter.” The AI agent 128 proceeds with extracting a user intent from the query, and mapping the user intent to a legal-clause-footer function (e.g., looking for such legal clause footers in the enterprise knowledge database 140) in the add-in based on the function description in AD and add-in manifests. The user intent can be saved in the data storage 134 as a part of the user intent data, plan data, action result data, DRM data 146.

Concurrently, AI agent 128 finds and displays a list of the most recent legal clause footers about a fixed coffee machine for the user to select. After the user selection of Footer C (e.g., a warranty clause-footer listed in Table 6), the AI agent 128 calls the legal-clause-footer function via the host application to have the add-in execute the function and send back the result. The AI agent 128 then updates the letters with the footers based on the result.

TABLE 6
Warranty: All repairs performed by EnterpriseA are covered by a limited warranty for a
period of 90 days from the date of service. This warranty covers parts and labor related to
the original repair only. It does not cover damage due to misuse, improper handling, or
unauthorized repairs. If the same issue reoccurs within the warranty period, please contact
us for a follow-up inspection at no additional cost. This warranty is non-transferable and
applies only to the original customer.

Alternatively, the AI agent 128 first asks the user what the user would like to do with the document as shown in the AI chat box 325b in FIG. 3D. The AI agent 128 receives a query of “adding legal clause footers to the letter,” and displays a follow-up question regarding what kind of legal clauses to add or which add-in to use. The AI agent 128 can input the letter to the LLM 130a to figure out legal clauses to add the letter for a manufacturer repaired coffee machine, as well as which add-in to use. The AI agent 128 then proceed with the same process as the in FIG. 3B to look for such legal clause footers in the enterprise knowledge database 140, as well as the call a corresponding add-in supporting the legal-clause-footer function.

In some implementations, the AI agent and add-in integration approach provides a feedback loop by augmenting thumbs up and thumbs down buttons for each AI-generated content item in the user interface 305. If the user dislikes a response, the feedback loop can ask why and use the input to improve the response. A thumbs down click could also prompt the user to indicate whether the response was too long, too short, missing information, and the like. The user prompts, the response, and the user feedback are submitted to the application services platform 110 to generate another response using the AI agent 128 and/or to improve the generative models. The AI-based content generation thus incorporates user feedback in real-time or in substantially real-time, and allows user inputs via intuitive user interfaces.

In some implementations, the application services platform 110 includes moderation services that analyze commands, user prompt(s), user feedback, and responses generated by the AI agent 128, to ensure that potentially objectionable or offensive content is not generated or utilized by the application services platform 110.

If potentially objectionable or offensive content is detected in the user prompt(s), the user feedback, and the AI-generated responses, the moderation services provides a blocked content notification to the client device 105 indicating that the prompt(s), the user data, and/or the response(s) is blocked from forming the system prompt. In some implementations, the web portal 122 discards any user data that includes potentially objectionable or offensive content and passes any remaining content that has not been discarded to the web portal 122 to be provided as an input to the AI agent 128. In other implementations, the AI agent 128 discards any content that includes potentially objectionable or offensive content and passes any remaining content that has not been discarded to the generative models as an input.

The moderation services can be implemented by a machine learning model trained to analyze the content of these various inputs and/or outputs to perform a semantic analysis on the content to predict whether the content includes potentially objectionable or offensive content. The moderation services can perform another check on the content using a machine learning model configured to analyze the words and/or phrase used in content to identify potentially offensive language/image/sound. The moderation services can compare the language used in the content with a list of prohibited terms/images/sounds including known offensive words and/or phrases, images, sounds, and the like. The moderation services can provide a dynamic list that can be quickly updated by administrators to add additional prohibited terms/images/sounds. The dynamic list may be updated to address problems such as words or phrases becoming offensive that were not previously deemed to be offensive. The words and/or phrases added to the dynamic list may be periodically migrated to the guard list as the guard list is updated. The specific checks performed by the moderation services may vary from implementation to implementation. If one or more of these checks determines that the textual content includes offensive content, the moderation services can notify the application services platform 110 that some action should be taken.

In some implementations, the moderation services generates a blocked content notification, which is provided to the client device 105. The native application 114 or the browser application 112 receives the notification and presents a message on a user interface of the application that the user prompt received by the web portal 122 could not be processed. The user interface provides information indicating why the blocked content notification was issued in some implementations. The user may attempt to refine a natural language prompt to remove the potentially offensive content. A technical benefit of this AI agent and add-in integration approach is that the moderation services provides safeguards against both user-created and model-created content to ensure that prohibited offensive or potentially offensive content is not presented to the user in the native application 114 or the browser application 112.

As mentioned, the application services platform 110 complies with privacy guidelines and regulations that apply to the usage of user data included in the content to be semantically analyzed to ensure that users have control over how the application services platform 110 utilizes their data. The user is provided with an opportunity to opt into the application services platform 110 to allow the application services platform 110 to access the user data and enable the generative models to generate a response according to user consent. In some implementations, the first time that an application, such as the native application 114 or the browser application 112 presents the data analysis assistant to the user, the user is presented with a message that indicates that the user may opt into allowing the application services platform 110 to use user data included in the content to support the content generation functionality. The user may opt into allowing the application services platform 110 to access all or a subset of user data included in the content to be semantically analyzed in a video. Furthermore, the user may modify their opt-in status at any time by selectively opting into or opting out of allowing the application services platform 110 from accessing and utilizing user data from the content as a whole or individually.

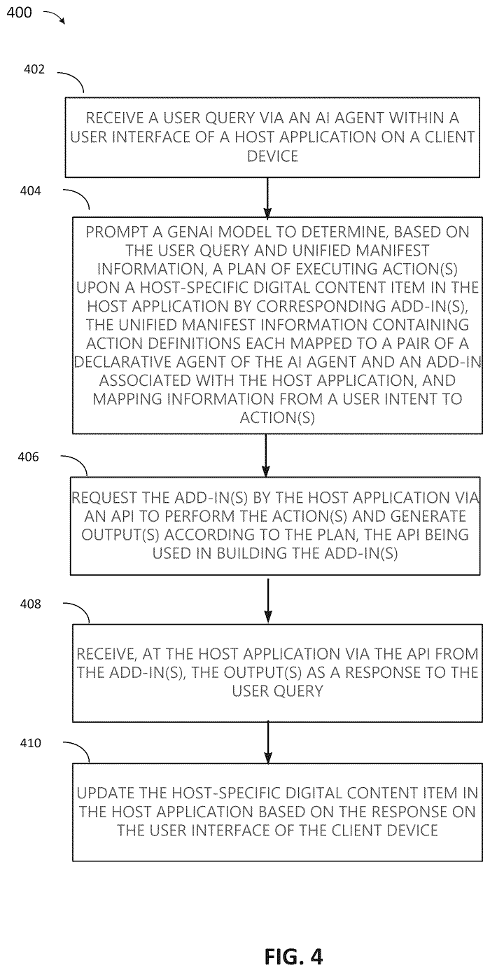

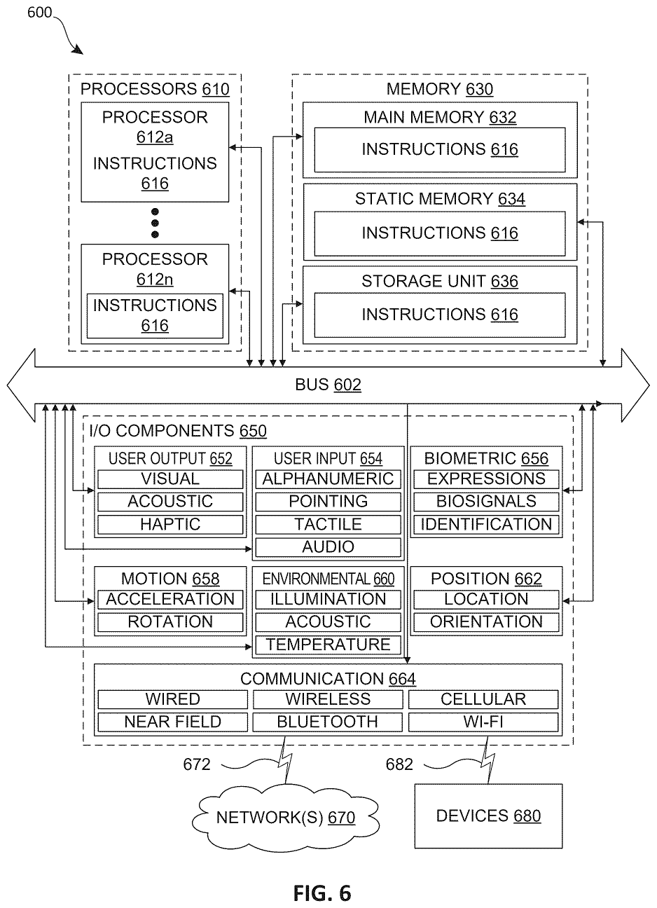

FIG. 4 is a flow chart of an example process for providing the email system integrating AI agents with host-application-specific add-ins according to the techniques disclosed herein. The process 400 can be implemented by the application services platform 110 or its components shown in the preceding examples. The process 400 may be implemented in, for instance, the example machine including a processor and a memory as shown in FIG. 6. As such, the application services platform 110 can provide means for accomplishing various parts of the process 400, as well as means for accomplishing embodiments of other processes described herein in conjunction with other components of the example computing environment 100. Although the process 400 is illustrated and described as a sequence of steps, it is contemplated that various embodiments of the process 400 may be performed in any order or combination and need not include all the illustrated steps.

In one embodiment, for example, in step 402, a web portal (e.g., the web portal 122) receives a user query via an artificial intelligence (AI) agent (e.g., the AI agent 112b) within a user interface (e.g., the user interface 305) of a host application (e.g., the host application 112a) on a client device (e.g., the client device 105). The user query involves a host-specific digital content item (e.g., a client letter in FIG. 3A) in the host application. For example, the host-specific digital content item includes at least one of a document, a spreadsheet, a presentation, a form, a diagram, a note, a website, an email, a calendar, a database, or a whiteboard.

In step 404, an AI agent (e.g., the AI agent 128 that presents as the AI agent 112b on the client device) prompts a generative AI model (e.g., the LLM 130a) to determine, based on the user query and unified manifest information, a plan of executing one or more actions (e.g., inserting a legal clause footer) upon the host-specific digital content item by one or more corresponding add-ins 126 (e.g., the word processing add-in 126a for inserting legal-clause-footer) associated with the host application.

In one implementation, the user can access the one or more corresponding add-ins 126 (e.g., the Contract Express) via the AI agent 128 on a user interface (e.g., the user interface 305 in FIG. 3A) of the client device 105. In another implementation, multiple special AI agents are provided on the user interface 305 (e.g., FIG. 3B) in addition to the AI agent 128. One special add-in agent is especially configured to handle prompts that require accessing the specific add-in associated with that special add-in agent. The system enhances functionality by offering multiple add-in agents in addition to the standard host AI agent, to handle tasks that require access to a particular add-in, allowing for more specialized and accurate responses. For example, the web portal 122 causes the user interface 305 to display the one or more corresponding add-ins as one or more add-in agents 325d-325g in addition to the AI agent 325b in the host application (e.g., FIG. 3B). In response to a user selection of one of the corresponding add-in agents (e.g., Contract Express 325g), causing the user interface 305 to display a chat box for the selected add-in agent (e.g., FIG. 3C). In this case, the user query is received via the selected add-in agent, and the user query involves the host-specific digital content item in the host application.

The unified manifest information contains action definitions each of which is mapped to a pair of a declarative agent (DA) of the AI agent (e.g., the AI agent 128) and an add-in (e.g., the add-in 112c) associated with the host application (e.g., the host application 112a), and mapping information from a user intent to one or more actions (including e.g., the action(s)/function(s) 202 in FIG. 2A). For example, the AI agent 128 retrieves the unified manifest information from at least one of a web application store (e.g., an app store carrying third party add-ins) or a web service (e.g., weather, stocks, GPS, and the like), and stores the unified manifest information for later use.

In one implementation, the one or more actions required to be taken with respect to the host-specific digital content item are determined by: mapping the user query to one or more user intents (e.g., inserting legal clause footer(s) in a client letter opened in a word processing application) in the unified manifest information, and mapping the one or more user intents to the one or more actions. In addition, the AI agent 128 validates the one or more user intents with a user input (e.g., clicking a button) via the user interface of the client device.

In step 406, the host application requests via an application programming interface (e.g., Office.js API) the one or more corresponding add-ins to perform the one or more actions and generate one or more outputs (e.g., legal clause footer(s)) according to the plan. The API was used in building the one or more corresponding add-ins.

In one implementation, the one or more corresponding add-ins executes the one or more actions and generates the one or more outputs in a browser sandbox (e.g., the add-in runtime sandbox 244) inside the host application. In another implementation, the AI agent 128 validates that the user has right (e.g., according to DRM) to access at least one of the one or more corresponding add-ins, or the one or more actions, and validates that the one or more actions are defined in respective manifests of the one or more corresponding add-ins. The host application's request to the one or more corresponding add-ins to perform the one or more actions is conditioned upon both of the user access right validation and the action defined in manifest validation. Optionally, the host application receives, via the API from the one or more corresponding add-ins, at least one callback for data required to execute the one or more actions (e.g., calling data back from the host application in step 234 in FIG. 2C).

Additionally, the generative AI model is further prompted to determine action data, a correlation identifier, a callback reference for a data response from the one or more actions, and includes one or more identifiers of the one or more actions and one or more identifiers of the one or more corresponding add-ins into the further determined data as mapped action context data (e.g., step 260 in FIG. 2D). The host application requests the one or more corresponding add-ins to perform the one or more actions by: sending one or more action calls associated with the one or more actions together with the mapped action context data from the AI agent to the host application (e.g., step 264 in FIG. 2D), and then from the host application to the one or more corresponding add-ins (e.g., step 266 in FIG. 2D). The one or more corresponding add-ins execute the one or more actions in response to the one or more action calls (e.g., step 268 in FIG. 2D).

In step 408, the host application receives via the API from the one or more corresponding add-ins, the one or more outputs as a response to the user query (e.g., step 270 in FIG. 2D). In step 410, the host application updates the host-specific digital content item based on the response on the user interface of the client device (e.g., a warranty clause-footer is displayed at the end of the client letter in FIG. 3B).

In another implementation, the AI agent 128 sends the one or more outputs from the host application to the generative AI model for additional processing (e.g., the plan requiring multiple calls to the generative AI model) according to the plan, and prompts the generative AI model to generate a second response to the user query based on the one or more additionally processed outputs. The host-specific digital content item is updated based on the second response on the user interface of the client device.

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the hardware modules described may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

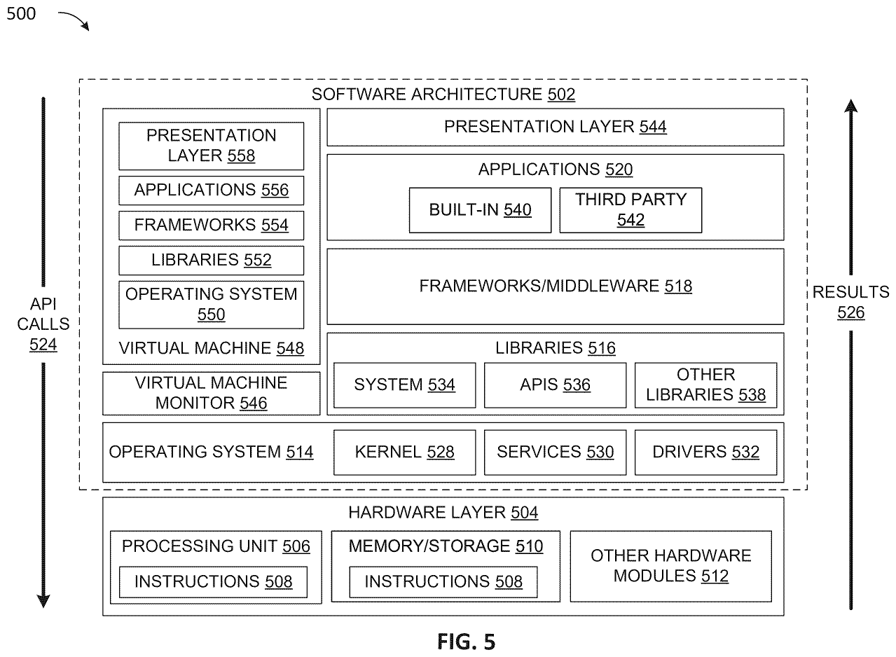

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may be executed on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than interacting directly with the OS 514. The libraries 516 may include system libraries 534 (for example, C standard library) that may provide functions such as memory allocation, string manipulation, and file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a neural processing unit (NPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor, and
a machine-readable storage medium storing executable instructions which, when executed by the processor, cause the processor alone or in combination with other processors to perform following operations:
receiving a user query via an artificial intelligence (AI) agent within a user interface of a host application on a client device, wherein the user query involves a host-specific digital content item in the host application;
prompting a generative AI model to determine, based on the user query and unified manifest information, a plan of executing one or more actions upon the host-specific digital content item by one or more corresponding add-ins associated with the host application, wherein the unified manifest information contains action definitions each of which is mapped to a pair of a declarative agent of the AI agent and an add-in associated with the host application, and mapping information from a user intent to one or more actions;
requesting the one or more corresponding add-ins by the host application via an application programming interface (API) to perform the one or more actions and generate one or more outputs according to the plan, the API being used in building the one or more corresponding add-ins;
receiving, at the host application via the API from the one or more corresponding add-ins, the one or more outputs as a response to the user query; and
updating the host-specific digital content item in the host application based on the response on the user interface of the client device.

2. The data processing system of claim 1, wherein the machine-readable storage medium further includes instructions configured to cause the processor alone or in combination with other processors to perform:
sending the one or more outputs from the host application to the generative AI model for additional processing according to the plan; and
prompting the generative AI model to generate a second response to the user query based on the one or more additionally processed outputs,
wherein the host-specific digital content item is updated based on the second response on the user interface of the client device.

3. The data processing system of claim 1, wherein the machine-readable storage medium further includes instructions configured to cause the processor alone or in combination with other processors to perform:
retrieving the unified manifest information from at least one of a web application store or a web service; and
storing the unified manifest information.

4. The data processing system of claim 1, wherein determining the one or more actions required to be taken with respect to the host-specific digital content item includes:
mapping the user query to one or more user intents in the unified manifest information; and
mapping the one or more user intents to the one or more actions.

5. The data processing system of claim 4, wherein the machine-readable storage medium further includes instructions configured to cause the processor alone or in combination with other processors to perform:
validating the one or more user intents with a user input via the user interface of the client device.

6. The data processing system of claim 1, wherein the machine-readable storage medium further includes instructions configured to cause the processor alone or in combination with other processors to perform:
validating that the user has right to access at least one of the one or more corresponding add-ins, or the one or more actions; and
validating that the one or more actions are defined in respective manifests of the one or more corresponding add-ins,
wherein requesting the one or more corresponding add-ins to perform the one or more actions is conditioned upon both of the validating.

7. The data processing system of claim 1, wherein the generative AI model is further prompted to determine action data, a correlation identifier, a callback reference for a data response from the one or more actions, and to include one or more identifiers of the one or more actions and one or more identifiers of the one or more corresponding add-ins into the further determined data as mapped action context data.

8. The data processing system of claim 7, wherein requesting the one or more corresponding add-ins to perform the one or more actions includes:
sending one or more action calls associated with the one or more actions together with the mapped action context data from the AI agent to the host application, and then from the host application to the one or more corresponding add-ins,
wherein the one or more corresponding add-ins execute the one or more actions in response to the one or more action calls.

9. The data processing system of claim 1, wherein the machine-readable storage medium further includes instructions configured to cause the processor alone or in combination with other processors to perform at least one of:
causing the one or more corresponding add-ins to execute the one or more actions and to generate the one or more outputs in a browser sandbox inside the host application.

10. The data processing system of claim 1, wherein the machine-readable storage medium further includes instructions configured to cause the processor alone or in combination with other processors to perform:
receiving, at the host application via the API from the one or more corresponding add-ins, at least one callback for data required to execute the one or more actions,
wherein the host-specific digital content item includes at least one of a document, a spreadsheet, a presentation, a form, a diagram, a note, a website, an email, a calendar, a database, or a whiteboard.

11. The data processing system of claim 1, wherein the machine-readable storage medium further includes instructions configured to cause the processor alone or in combination with other processors to perform:
causing the user interface to display the one or more corresponding add-ins as one or more add-in agents in addition to the AI agent in the host application,
in response to a user selection of one of the corresponding add-in agents, causing the user interface to display a chat box for the selected add-in agent,
wherein the user query is received via the selected add-in agent, and the user query involves the host-specific digital content item in the host application.

12. A method comprising:
receiving a user query via an artificial intelligence (AI) agent within a user interface of a host application on a client device, wherein the user query involves a host-specific digital content item in the host application;
prompting a generative AI model to determine, based on the user query and unified manifest information, a plan of executing one or more actions upon the host-specific digital content item by one or more corresponding add-ins associated with the host application, wherein the unified manifest information contains action definitions each of which is mapped to a pair of a declarative agent of the AI agent and an add-in associated with the host application, and mapping information from a user intent to one or more actions;
requesting the one or more corresponding add-ins by the host application via an application programming interface (API) to perform the one or more actions and generate one or more outputs according to the plan, the API being used in building the one or more corresponding add-ins;
receiving, at the host application via the API from the one or more corresponding add-ins, the one or more outputs as a response to the user query; and
updating the host-specific digital content item in the host application based on the response on the user interface of the client device.

13. The method of claim 12, further comprising:
sending the one or more outputs from the host application to the generative AI model for additional processing according to the plan; and
prompting the generative AI model to generate a second response to the user query based on the one or more additionally processed outputs,
wherein the host-specific digital content item is updated based on the second response on the user interface of the client device.

14. The method of claim 12, further comprising:
retrieving the unified manifest information from at least one of a web application store or a web service; and
storing the unified manifest information.

15. The method of claim 12, wherein determining the one or more actions required to be taken with respect to the host-specific digital content item includes:
mapping the user query to one or more user intents in the unified manifest information; and
mapping the one or more user intents to the one or more actions.

16. The method of claim 12, further comprising:
validating the one or more user intents with a user input via the user interface of the client device.

17. A non-transitory computer readable medium on which are stored instructions that, when executed, cause a programmable device to perform functions of:
receiving a user query via an artificial intelligence (AI) agent within a user interface of a host application on a client device, wherein the user query involves a host-specific digital content item in the host application;
prompting a generative AI model to determine, based on the user query and unified manifest information, a plan of executing one or more actions upon the host-specific digital content item by one or more corresponding add-ins associated with the host application, wherein the unified manifest information contains action definitions each of which is mapped to a pair of a declarative agent of the AI agent and an add-in associated with the host application, and mapping information from a user intent to one or more actions;
requesting the one or more corresponding add-ins by the host application via an application programming interface (API) to perform the one or more actions and generate one or more outputs according to the plan, the API being used in building the one or more corresponding add-ins;
receiving, at the host application via the API from the one or more corresponding add-ins, the one or more outputs as a response to the user query; and
updating the host-specific digital content item in the host application based on the response on the user interface of the client device.

18. The non-transitory computer readable medium of claim 17, wherein the instructions when executed, further cause the programmable device to perform:
sending the one or more outputs from the host application to the generative AI model for additional processing according to the plan; and
prompting the generative AI model to generate a second response to the user query based on the one or more additionally processed outputs,
wherein the host-specific digital content item is updated based on the second response on the user interface of the client device.

19. The non-transitory computer readable medium of claim 17, wherein the instructions when executed, further cause the programmable device to perform:
retrieving the unified manifest information from at least one of a web application store or a web service; and
storing the unified manifest information.

20. The non-transitory computer readable medium of claim 17, wherein determining the one or more actions required to be taken with respect to the host-specific digital content item includes:
mapping the user query to one or more user intents in the unified manifest information; and
mapping the one or more user intents to the one or more actions.
